(19) United States
(12) Patent Application Publication
(10) Pub. No.: US 2024/0322435 A1
(43) Pub. Date: Sep. 26, 2024

(54) ANTENNA DEVICE AND VEHICLE ANTENNA DEVICE

(71) Applicant: AGC Inc., Tokyo (JP)

(72) Inventors: Toshiki SAYAMA, Tokyo (JP); Hideaki Shoji, Tokyo (JP); Yusuke Kato, Tokyo (JP)

(73) Assignee: AGC Inc., Tokyo (JP)

(21) Appl. No.: 18/678,348

(22) Filed: May 30, 2024

Related U.S. Application Data
(63) Continuation of application No. PCT/JP2022/044074, filed on Nov. 29, 2022.

(30) Foreign Application Priority Data
Dec. 3, 2021 (JP) 2021-197303

(51) Int. Cl. H01Q 9/04; H01Q 1/32; H01Q 9/40; H01Q 13/08

(52) U.S. Cl. CPC H01Q 9/0414; H01Q 9/40; H01Q 13/08; H01Q 1/32

(57) ABSTRACT

An antenna includes a radiation plate 56 equipped with a radiation surface that radiates radio waves and a feed point that is a location supplied with power from a transmission line. When looking at the radiation plate along a horizontal direction, the feed point is provided at a position separated from a centroid of the radiation plate by a distance A. When looking along a thickness direction of the radiation plate, locations between an end portion of the transmission line connected to the feed point and an intersection portion intersecting with a peripheral edge portion of the conductor plate, overlap in the thickness direction of the radiation plate with a specified area between a third straight line and a fourth straight line.

### CROSS-REFERENCE TO RELATED APPLICATION

This application is a Continuation of International Application No. PCT/JP2022/044074, filed Nov. 29, 2022, which claims priority to Japanese Patent Application No. 2021-197303 filed Dec. 3, 2021. Each of the above applications is hereby expressly incorporated by reference, in its entirety, into the present application.

### BACKGROUND

### Technical Field

The present disclosure relates to an antenna device and a vehicle antenna device.

### Related Art

In accordance with recently improved levels of autonomous-driving, there is a tendency to install vehicles with a communication system to implement Vehicle to Everything (V2X), such as vehicle-to-vehicle communication and roadside-to-vehicle communication. Vehicles installed with a V2X communication system utilize, for example, narrow-band wavelength radio waves in a 5.8 GHz band or a 5.9 GHz band, and are able to acquire various safety related information from outside the vehicle. This means that there is a demand for V2X antennas capable of transmitting and receiving vertically polarized radio waves of a frequency band satisfying a V2X communication standard, while also achieving desired gain and directionality.

In a V2X antenna, for example, there is a demand for directionality that implements a desired gain over a range of 90° (180°) in a horizontal plane, centered on a progression direction of the vehicle. There is no limitation to where on a vehicle such V2X antennas are disposed, as long as they are able to realize the desired gain and directionality.

Japanese Patent Application Laid-Open (JP-A) No. 2019-75644 and International Publication (WO) No. 2019/163521 disclose an antenna device including a radiation surface on the vehicle inside that faces toward a windshield or faces toward a rear glass, with the antenna device configured for use as an onboard antenna for V2X communication. In such antenna devices, electrical feed to the radiation plate (radiation conductor) is performed from one end portion of a transmission line such as a coaxial cable or the like, and signal control is performed in the antenna device by an electronic control unit (ECU) connected to a portion at the other end of the transmission line.

The antenna device described in JP-A No. 2019-75644 includes a coaxial connector for a substrate provided on a base board side at a position on the opposite side to the radiation surface. In the technology of JP-A No. 2019-75644, one end of a feed coaxial cable is connected to this coaxial connector for a substrate extending along a normal direction to the radiation surface.

The antenna device of WO No. 2019/163521 includes a coaxial connector for a substrate provided at a base board side positioned on the opposite side to the radiation surface. In WO No. 2019/163521, one end of a feed coaxial cable is connected to this coaxial connector for a substrate. A portion at one end of this coaxial cable is formed in an L-shape, and so the coaxial cable extends in a vehicle width direction that is orthogonal to the normal direction to the radiation surface.

### SUMMARY

However, in the onboard antenna device described in JP-A No. 2019-75644, the coaxial cable connected to the coaxial connector for a substrate extends in a depth direction orthogonal to the radiation surface, and so there is a problem that this makes it difficult to save space in the front-rear direction of the limited space inside a vehicle.

Moreover, in the onboard antenna device described in WO No. 2019/163521, the coaxial cable connected to the coaxial connector for a substrate extends in the vehicle width direction, and so although this enables space saving to be achieved in the front-rear direction of the vehicle interior space, there is an issue in that the antenna device for transmitting and receiving vertically polarized waves finds it difficult to obtain directionality together with the desired gain over the above range.

In consideration of the above circumstances, the present disclosure provides an antenna device capable of implementing antenna gain accompanying desired directionality while also enabling a saving to be achieved in space occupied by an object including the transmission line for electrical feed, and especially an antenna device and vehicle antenna device capable of being utilized as a V2X antenna.

### Solution to Problem

An antenna device according to the present disclosure includes an antenna that transmits and receives radio waves of a prescribed frequency band, and a transmission line that feeds electricity to a conductor plate that is a portion of the antenna. The conductor plate includes a radiation plate that is equipped with a radiation surface for radiating radio waves and is equipped with a feed point that is a location supplied with power from the transmission line. The feed point is provided at a position separated by a distance A from a centroid of the radiation plate when the radiation plate is viewed along a horizontal direction. A first straight line passes through the centroid and the feed point, a second straight line is orthogonal to the first straight line and passes through the centroid, a third straight line passes through the feed point and is parallel to the second straight line, and a fourth straight line is parallel to the second straight line and is symmetrical to the third straight line with respect to the second straight line. The centroid overlaps with the conductor plate when viewed along the thickness direction of the radiation plate. When viewed along the thickness direction of the radiation plate, locations between an end portion of the transmission line connected to the feed point and an intersection portion intersecting with a peripheral edge portion of the conductor plate overlap in the thickness direction of the radiation plate with a specified area between the third straight line and the fourth straight line.

The antenna device and the vehicle antenna device according to the present disclosure are capable of implementing antenna gain with desired directionality while also enabling a space saving to be achieved in space occupied by an object including a transmission line employed for electrical feed.

### BRIEF DESCRIPTION OF DRAWINGS

FIG. 1 is a plan view illustrating a vehicle with which a vehicle antenna device is applied according to a first exemplary embodiment of the present disclosure, as viewed from a vertical direction.

FIG. 2 is a schematic cross-section of a front section of a vehicle and a rear section of the vehicle.

FIG. 3 is a front view of a vehicle antenna device and a roof section.

FIG. 4 is a back view of a vehicle antenna device.

FIG. 5 is a cross-section of a vehicle antenna device taken along arrow line 5-5 of FIG. 3.

FIG. 6 is a front view of a vehicle antenna device of a comparative example.

FIG. 7 is a cross-section of a vehicle antenna device of a comparative example taken along arrow line 7-7 of FIG. 6.

FIG. 8 is a diagram illustrating measurement results of directionality of a vehicle antenna device of an Example 1 that is a first exemplary embodiment.

FIG. 9 is a diagram illustrating measurement results of directionality of a vehicle antenna device of an Example 2 that is a comparative example.

FIG. 10 is a back view of a vehicle antenna device according to a second exemplary embodiment of the present disclosure.

FIG. 11 is a back view of a vehicle antenna device according to a third exemplary embodiment of the present disclosure.

FIG. 12 is a back view of a vehicle antenna device according to a fourth exemplary embodiment of the present disclosure.

FIG. 13 is a front view of a vehicle antenna device according to a fifth exemplary embodiment of the present disclosure.

### DETAILED DESCRIPTION

### First Exemplary Embodiment

Description follows regarding a vehicle antenna device 40A according to a first exemplary embodiment of the present disclosure, with reference to the appended drawings. As described later, the vehicle antenna device 40A of the present exemplary embodiment is provided to a vehicle 10. As appropriate in the drawings, an X axis is parallel to a vehicle width direction of the vehicle 10, a Y axis is parallel to a vehicle front-rear direction, and a Z axis is a “vertical direction” parallel to a vehicle up-down direction. Furthermore, an arrow FR indicates forward in the vehicle front-rear direction, an arrow UP indicates upward in the vehicle up-down direction, and an arrow LF indicates left in the vehicle width direction. An XY plane is a plane passing through the X axis and the Y axis, and is also called a “horizontal plane”. Namely, in the following description the vehicle 10 is positioned on a horizontal plane, with the vehicle up-down direction aligned with the vertical direction, with the XY plane aligned with a horizontal plane, and with the vertical direction corresponding to a normal direction with respect to the horizontal plane. Furthermore, an XZ plane is a plane passing through the X axis and the Z axis, and a YZ plane is a plane passing through the Y axis and the Z axis.

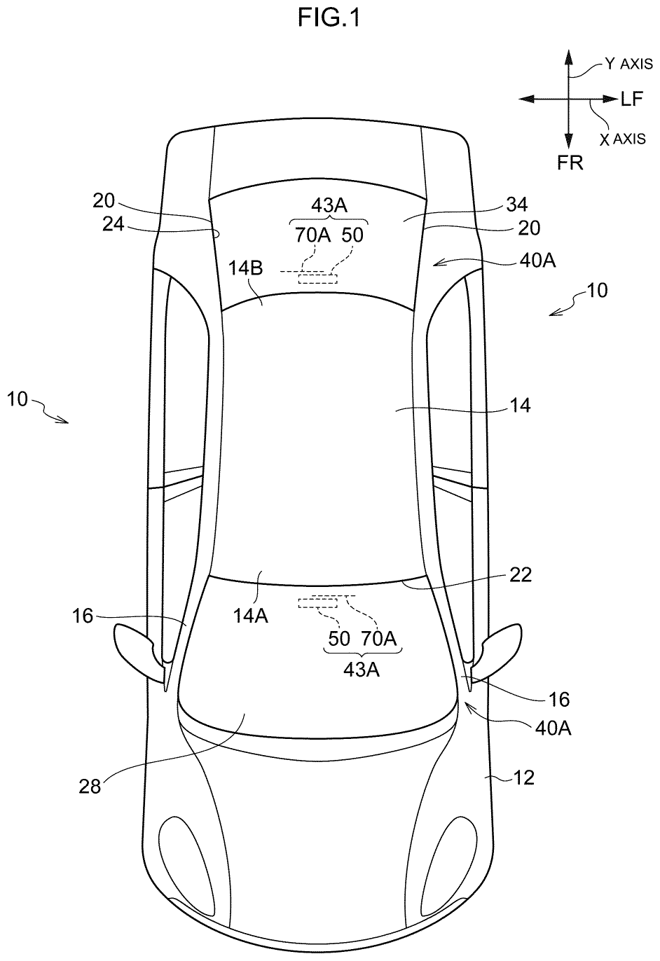

The vehicle 10 illustrated in FIG. 1 includes a vehicle body 12 including a metal body. This metal body includes, for example, a roof section 14, A pillars (front pillars) 16, and C pillars (rear pillars) 20.

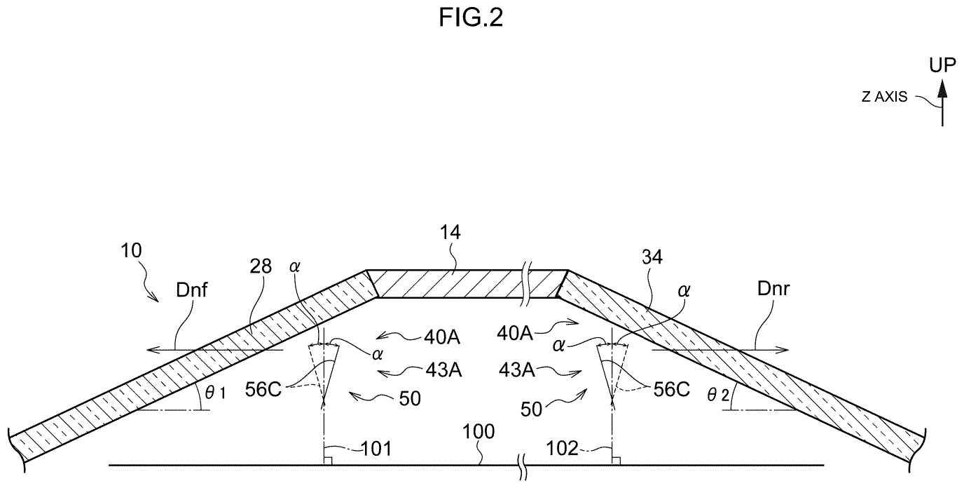

A substantially square shaped forward opening 22 is formed in a front section of the vehicle body 12. An upper edge portion of the forward opening 22 is adjacent to a front edge portion 14A of the roof section 14, and left and right side edge portions of the forward opening 22 are adjacent to the left and right A-pillars 16. A windshield (vehicle window glass) 28 is fitted to the forward opening 22, and peripheral edge portions of the windshield 28 are fixed to peripheral edge portions of the forward opening 22 with an adhesive such as a urethane resin or the like. As illustrated in FIG. 2, the windshield 28 is, in side view (along the X axis direction), inclined at an angle θ1 with respect to an XY plane 100 corresponding to a horizontal plane, such that a lower end portion thereof is positioned further forward than the upper end portion thereof.

A substantially square shaped rearward opening 24 is formed at a rear section of the vehicle body 12. An upper edge portion of the rearward opening 24 is adjacent to the rear edge portion 14B of the roof section 14, and left and right side edge portions of the rearward opening 24 are adjacent to the left and right C-pillars 20. A rear glass (vehicle window glass) 34 is fitted to the rearward opening 24, with peripheral edge portions of the rear glass 34 fixed to peripheral edge portions of the rearward opening 24 with an adhesive such as a urethane resin or the like. As illustrated in FIG. 2, the rear glass 34 is, in side view (along the X axis direction), inclined at an angle θ2 with respect to the XY plane 100 corresponding to a horizontal plane such that a lower end portion thereof is positioned further rearward than an upper end portion thereof. Moreover, as illustrated in FIG. 2, a communication antenna 50 is disposed such that a normal direction Dnf facing forward with respect to the radiation surface 56C of the radiation plate 56 passes through the windshield 28.

Furthermore, as illustrated in FIG. 1 and FIG. 2, the communication antenna 50 is attached to a vehicle up-down direction upper portion of a principal surface of the windshield 28 through a bracket, omitted in the drawings. The windshield 28, the communication antenna 50, and a coaxial cable 70A, described later, are configuration elements of the vehicle antenna device 40A. Furthermore, the communication antenna 50 and the coaxial cable 70A are configuration elements of an antenna device 43A. Note that the coaxial cable 70A is a type of transmission line for transmitting a high frequency signal, and other examples of the transmission line include a microstrip line, a strip line, a coplanar waveguide, a grounded coplanar waveguide (GCPW), a coplanar strip, a slot line, a waveguide, and the like. In the present specification, the transmission line is described as the coaxial cable 70A, unless explicitly stated otherwise. The communication antenna 50 of the present exemplary embodiment is a vertically polarized wave antenna having a higher antenna gain for transmitting and receiving vertically polarized waves than for transmitting and receiving horizontally polarized waves. The V2X antenna described below is an antenna capable of transmitting and receiving using vertically polarized waves, and is especially able to be utilized for radio waves in the 5.8 GHz band or radio waves in the 5.9 GHz band.

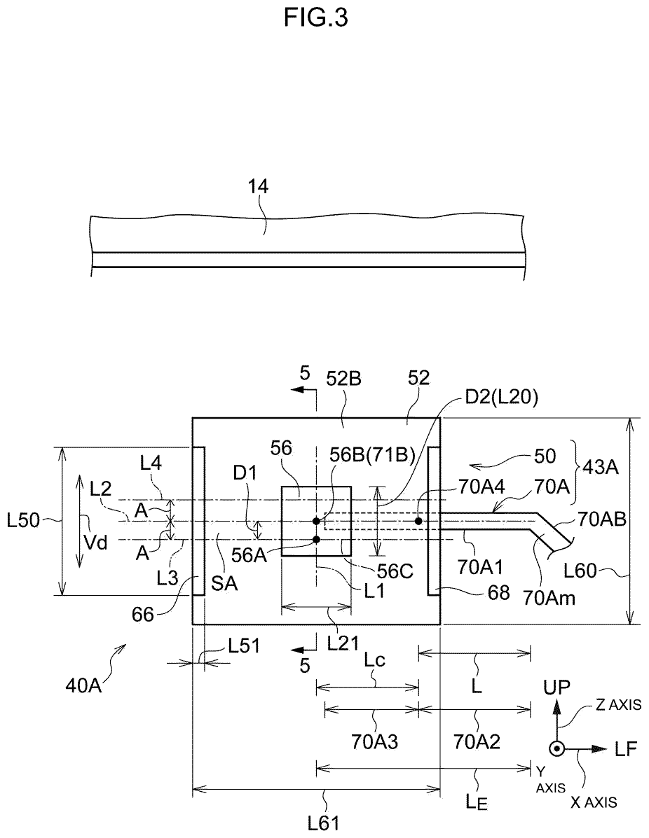

Next description follows regarding the communication antenna 50 of the vehicle antenna device 40A according to the present exemplary embodiment (hereinafter simply referred to as “antenna 50”). As illustrated in FIG. 3 to FIG. 5, the antenna 50 of the present exemplary embodiment includes a dielectric substrate 52, a ground conductor plate 54, a radiation plate (radiation conductor) 56, a feeding portion 60, and a connecting conductor 62. The ground conductor plate 54 and the radiation plate 56 correspond to a conductor plate. Similar applies in the second to the fourth exemplary embodiments. Note that, as described later, the antenna 50 may include at least one of a first element 66 or a second element 68, or may include both of the first element 66 and the second element 68, which are parasitic conductor plates.

The first element 66 and the second element 68 are independent conductor plates, neither connected to a core line (signal line) 71 of the coaxial cable 70A nor connected to a ground conductor line 75 (earth line) of the coaxial cable 70A. The antenna 50 according to the present exemplary embodiment is a patch antenna (micro-strip antenna). Although the antenna 50 according to the present exemplary embodiment is capable of being utilized as a V2X antenna, it may be configured so as to be capable of transmitting and receiving linearly polarized waves of a band different therefrom.

As illustrated in FIG. 3 to FIG. 5, the radiation plate 56 having a smaller surface area than the ground conductor plate 54 is provided to a principal surface 52B of the dielectric substrate 52. Examples of materials configuring the radiation plate 56 include, for example, silver or copper, but another conductive material may be employed therefor. Although the face-on shape of the illustrated radiation plate 56 is a square shape, there is no limitation to such a shape. Moreover, examples of materials configuring the first element 66 and the second element 68 include, for example, silver or copper, but another conductive material may be employed therefor. Furthermore, although the illustrated first element 66 and second element 68 are rectangular shaped in front view, a shape other than a rectangular shape may be employed therefor. However, giving the first element 66 and second element 68 a shape that extends along the Z axis direction in front view raises the antenna gain in the X axis direction (vehicle width direction), and this facilitates securing stable directionality.

The dielectric substrate 52 has a plate shape or a film shape, and is typically a cuboidal shaped dielectric layer. However, such “plate shapes or film shapes” may include, for example, portions having a protruding shape, indented shape, or wavy shape. Similar applies to the ground conductor plate 54, the radiation plate 56, the first element 66, and second element 68, and these should be formed in a thin planar shape typically thinner in thickness than the dielectric layer. Forming these in planar shapes facilitates prediction of antenna gain characteristics of the antenna 50.

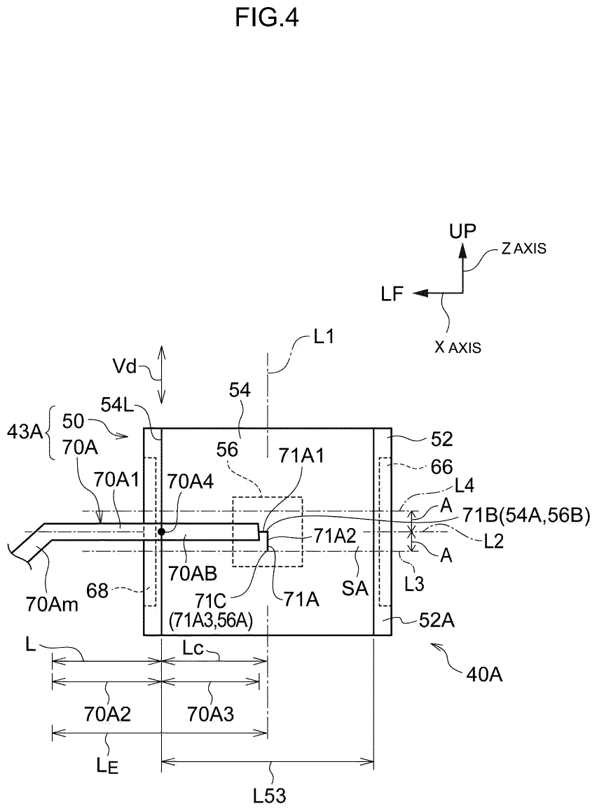

Moreover, although the face-on shape of the dielectric substrate 52 illustrated in FIG. 3 and FIG. 4 is a rectangular shape having a shorter dimension in the Z axis direction than in the X axis direction (vehicle width direction), the face-on shape of the dielectric substrate 52 may be a square shape, and may be a freely selected shape such as a polygonal shape other than a rectangular shape, a circular shape, or a shape including a curved outer edge. The dielectric substrate 52 includes a principal surface 52A on one thickness direction side, and the principal surface 52B parallel to the principal surface 52A. The dielectric substrate 52 may be formed using, for example, a glass epoxy board, a ceramic board, a fluororesin board, or the like. Note that giving the dielectric substrate 52 a face-on shape that is a rectangular shape (long in the vehicle width direction) enables placement regions for the first element 66 and second element 68 to be secured on at least one principal surface out of the principal surface 52A or the principal surface 52B.

The ground conductor plate 54 that serves as grounding for the antenna 50 is provided to the principal surface 52A of the dielectric substrate 52. Examples of materials configuring the ground conductor plate 54 include, for example, silver or copper, however another conductive material may be employed therefor. Although, as illustrated in FIG. 4, a face-on shape of the ground conductor plate 54 is a square shape, there is no limitation to this shape. Note that when the ground conductor plate 54 is square shaped, the dielectric substrate 52 may be a square shape having the same dimensions as the ground conductor plate 54, and such cases enable a space saving to be achieved because the antenna 50 has a dimension shorter in the (vehicle) width direction than for a rectangular shape.

The feeding portion 60 is a location where electricity is fed either by a contact or non-contact method, and is connected to one end portion 71A of the signal line (core line) 71 of the coaxial cable 70A, described later.

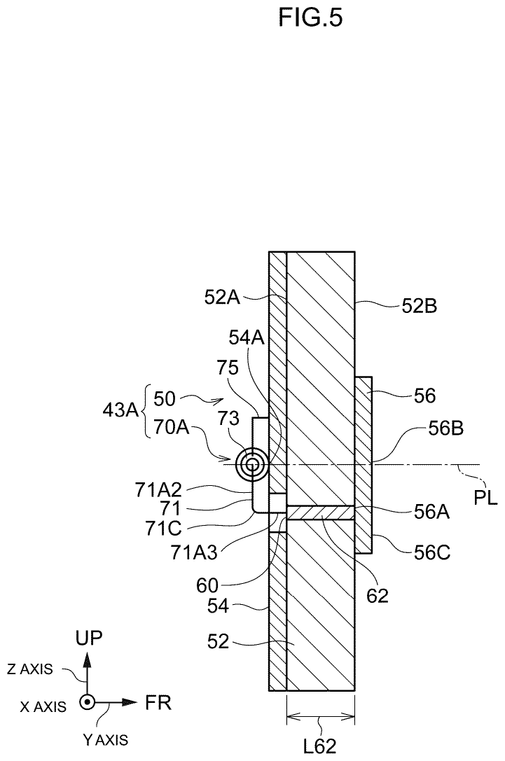

The connecting conductor 62 contained in the antenna 50 is a conductor pin provided inside a through hole piercing the dielectric substrate 52 in the plate thickness direction thereof. One end of the connecting conductor 62 is connected to the feeding portion 60, and the other end thereof is connected to a connection point (feed point) 56A of the radiation plate 56. The one end of the connecting conductor 62 does not contact the ground conductor plate 54. As illustrated in FIG. 3, in front view, the connection point 56A is separated from a centroid 56B of the radiation plate 56 by a distance D1. Note that in the present specification “front view” means viewing the antenna 50, 80 along the Y direction. In other words, “front view” corresponds to looking along a normal direction to the radiation surface 56C, and is hereafter referred to as “front view”. The Z axis dimension of the radiation plate 56 in front view is D2. The positional relationship of the connection point 56A in such cases should satisfy 0.05<D1/D2<0.45. Furthermore, D1/D2 is preferably about ⅙. As illustrated in FIG. 5, the centroid 56B of the radiation plate 56 and a centroid 54A of the ground conductor plate 54 are positioned on a straight line PL passing through in a normal direction to the radiation surface 56C. Note that the core line of the coaxial cable 70A may be connected to the feed point 56A without being connected through the connecting conductor 62.

As described above, the antenna 50 may include at least one of the first element 66 or the second element 68 that are parasitic conductor plates. As illustrated in FIG. 3 and FIG. 4, the first element 66 and second element 68 are disposed separated from each other in the vehicle width direction (horizontal direction), and in particular these parasitic conductor plates are provided in the antenna 50 to the principal surface 52B of the dielectric substrate 52. In front view of the antenna 50, the dielectric substrate 52, the first element 66, and second element 68 are respectively positioned at each side of the radiation plate 56.

Furthermore, although not illustrated in the drawings, the radiation plate 56, the first element 66, and the second element 68 are positioned in the same plane as each other when the antenna 50 is viewed along the Z axis direction. However, at least one of the first element 66 or the second element 68 may be disposed on an opposite side to the ground conductor plate 54 with respect to the principal surface 52B of the dielectric substrate 52, and may be disposed on an opposite side to the radiation plate 56 with respect to the principal surface 52A, and may be disposed on the principal surface 52A (at a position not in contact with the ground conductor plate 54). In such cases, at least one of the first element 66 or the second element 68 may partially or wholly overlap with the ground conductor plate 54 in front view of the dielectric substrate 52, and may partially overlap the radiation plate 56 except at the centroid 56B thereof.

The coaxial cable (transmission line) 70A illustrated in FIG. 3 to FIG. 5 includes at least the signal line 71 and a shield cover (external conductor) 73. Hereafter, locations of the coaxial cable (transmission line) 70A excluding the two end portions of the signal line 71 are called a main body 70AB. The two end portions of the signal line 71 are locations of the signal line 71 that project outside from the two ends of the shield cover 73. The coaxial cable 70A is flexible as a whole. As illustrated in FIG. 5, a distal end of one end portion 71A of the signal line 71 is connected to the connecting conductor 62, and is connected to the feeding portion 60 through the connecting conductor 62. One portion of the shield cover 73 serves as the ground conductor line 75 (earth line) and is connected to the ground conductor plate 54.

The main body 70AB of the coaxial cable 70A is positioned with respect to the dielectric substrate 52 further rearward (to the opposite side) than the ground conductor plate 54. The main body 70AB is preferably disposed in close proximity to, or in contact with, the ground conductor plate 54 in order to narrow a width in the Y axis direction (depth) of the vehicle antenna device 40A. In the antenna device 43A illustrated in FIG. 3 and FIG. 4, a portion of the main body 70AB of the coaxial cable 70A including an end portion on the one end portion 71A side is configured by a straight line shaped portion 70A1 parallel to the X axis. The relative positions of the antenna 50 and the straight line shaped portion 70A1 are maintained in the states illustrated in FIG. 3 to FIG. 5 by a non-illustrated fixing means. Note that the fixing means may include a non-illustrated casing for housing the antenna 50 and a connector customized for the coaxial cable 70A fixed to the back face (on the opposite side to the radiation direction) of the casing. Such a connector may have a structure that ensures there is no positional displacement of the end portion on the feeding portion 60 side of the coaxial cable 70A.

Moreover, locations of one portion of the straight line shaped portion 70A1 that are positioned further outside than a (left) side edge 54L of the ground conductor plate 54 in FIG. 4 are defined as being a non-overlapping portion 70A2. Furthermore, locations of the remaining portion of the straight line shaped portion 70A1 that are locations overlapping with the side edge 54L of the ground conductor plate 54 in front view, and are locations positioned further toward a central portion of the antenna 50 (dielectric substrate 52) than the side edge 54L, are defined as being an overlapping portion 70A3. As illustrated in FIG. 3 and FIG. 4, a length along the X axis direction of the straight line shaped portion 70A1 and the end portion 71A is L_{E}. L_{E} referred to here is the sum of a contiguous length L of the non-overlapping portion 70A2 along the X axis direction, added to a length L_{C} of locations of the overlapping portion 70A3 and the end portion 71A that overlap with a second straight line L2, as described later. Furthermore, the coaxial cable 70A may include an intermediate portion 70Am that is positioned further outside with respect to the centroid than the straight line shaped portion 70A1, and that is inclined with respect to the straight line shaped portion 70A1 in front view.

The length L, which is contiguous along the X axis direction, of the non-overlapping portion 70A2 from the side edge 54L as an a starting point should satisfy L≥0.10×λ×k, wherein λ is a wavelength in air of radio waves being transmitted and received by the antenna 50, and k is a shortening coefficient of wavelength of a surrounding medium (for air: k=1). The length L preferably satisfies the above expression in particular for a configuration in which the antenna 50 includes one or other, or both, of the first element 66 and/or the second element 68. Moreover, preferably L satisfies L≥0.15×λ×k, and more preferably satisfies L≥0.20×λ×k. Moreover, L_{E} may satisfy L_{E}≥0.20×λ×k, preferably satisfies L_{E}≥0.30×λ×k, and more preferably satisfies L_{E}≥0.40×λ×k.

As illustrated in FIG. 3 to FIG. 5, in the coaxial cable 70A, bending portions 71B, 71C may be provided at two places on the end portion 71A of the signal line 71. In the present example a location positioned between the distal end of the straight line shaped portion 70A1 and the bending portion 71B is configured by a first portion 71A1 parallel to the straight line shaped portion 70A1. A location of the end portion 71A which is positioned between the bending portion 71 Band the bending portion 71C is configured by a second portion 71A2 substantially orthogonal to the first portion 71A1 and parallel to a first straight line L1. A location between the distal end of the end portion 71A and the bending portion 71C is configured by a third portion 71A3 substantially orthogonal to the second portion 71A2 and parallel to the Y axis. The distal end of the third portion 71A3 is connected to the feeding portion 60 through the connecting conductor 62. In front view of the ground conductor plate 54, the bending portion 71B may overlap with the centroid 56B of the radiation plate 56 and the centroid 54A of the ground conductor plate 54.

Note that in the present specification reference to the transmission line, such as the coaxial cable or the like, overlapping with the centroid in front view of the ground conductor plate 54, means that part of the transmission line overlaps with the centroid. Furthermore, in front view of the ground conductor plate 54, the bending portion 71C and the third portion 71A3 overlap with the connection point 56A of the radiation plate 56. Note that the end portion 71A of the signal line 71 may, for example, include the bending portions 71B, 71C that overlap with the centroid 56B in a stripped state, however the end portion 71A of the signal line 71 may be connected to the connecting conductor 62, and may be connected to the feeding portion 60 through the connecting conductor 62, by being bent in a curved shape to reduce mechanical damage. Furthermore, as described later, the coaxial cable 70A should be disposed inside a specified area SA.

Moreover, as illustrated in FIG. 5, the shield cover 73 is connected to the ground conductor plate 54 such that the potential thereof is the earth potential. Furthermore, an end portion of the signal line 71 on the opposite side to the end portion 71A may be connected to a control device for controlling the antenna 50, and an end portion of the shield cover 73 on the opposite side to the end portion 71A may be grounded.

As illustrated in FIG. 3, the first straight line L1 is parallel to the Z axis and passes through the connection point 56A of the antenna 50 attached to an upper portion of a principal surface on the vehicle inside of the windshield 28 through a (non-illustrated) bracket. Namely, in front view the first straight line L1 is parallel to a vibration direction Vd (vertical direction) of vertically polarized waves that the antenna 50 is capable of transmitting and receiving.

As illustrated in FIG. 3, a straight line parallel to the X axis and passing through the centroid 56B in front view is defined as being the second straight line L2. Furthermore, a straight line parallel to the second straight line L2 and passing through the connection point 56A is defined as being a third straight line L3. The interval between the second straight line L2 and the third straight line L3 is defined as being a distance A. Furthermore, a straight line parallel to the second straight line L2 and separated by a distance A from the second straight line L2 on the opposite side to the third straight line L3 is defined as being a fourth straight line L4. Namely, the third straight line L3 and the fourth straight line L4 have a symmetrical positional relationship to each other with respect to the second straight line L2. An area between the third straight line L3 and the fourth straight line L4 in the antenna 50 is defined as being the specified area SA. Furthermore, a location of the coaxial cable 70A overlapping with the side edge 54L that is a portion at a peripheral edge of the ground conductor plate 54 in front view is defined as being an intersection portion 70A4.

Locations between the distal end of the end portion 71A and the intersection portion 70A4 should be positioned inside the specified area SA in front view. Furthermore, in front view the overlapping portion 70A3 and the first portion 71A1 may overlap with the second straight line L2, and the second portion 71A2 and the third portion 71A3 may overlap with the first straight line L1. Furthermore, the non-overlapping portion 70A2 (at least a portion thereof) and the overlapping portion 70A3 of the coaxial cable 70A should be positioned between the third straight line L3 and the fourth straight line L4 in front view. More specifically, the non-overlapping portion 70A2 (at least a portion thereof) and the overlapping portion 70A3 of the coaxial cable 70A are preferably positioned on the second straight line L2 in front view. Note that when the transmission line is the coaxial cable 70A, “the transmission line is positioned on the second straight line L2” indicates that the second straight line L2 is disposed so as to overlap with the shield cover 73 or the signal line 71 of the coaxial cable 70A in front view, and may be disposed overlapping with the signal line 71. Furthermore, when the transmission line is a strip line, a microstrip line, or a coplanar feed line, then “the transmission line is positioned on the second straight line L2” indicates that the second straight line L2 is disposed overlapping with the strip line, the microstrip line, or the coplanar feed line.

The greater a proportion of a length (L_{C}) of a portion of the (axis of) the overlapping portion 70A3 and the end portion 71A with respect to half the length of the length L53 in the X axis (vehicle width) direction of the ground conductor plate 54 is, the easier it is for the desired directionality to obtained by the antenna 50. This portion having the length (L_{C}) overlaps the second straight line L2. Namely, in cases in which the overlapping portion 70A3 of the coaxial cable 70A overlaps the specified area SA in front view, taking “L53/2” as 100%, then the proportion of the length L_{C} described above should be 30% or greater, is preferably 50% or greater, and is more preferably 70% or greater. In the antenna device 43A of the present exemplary embodiment, the proportion of the length L_{C} described above is 100%.

Next, description follows regarding the angle of elevation and the angle of dip of the antenna 50. As illustrated in FIG. 2, the antenna 50 is appropriately installed such that an inclination angle α of the radiation surface 56C of the radiation plate 56 with respect to a vertical direction 101 is in a range of ±15° when the front section of the vehicle 10 is in side view (along the X axis direction). Moreover, as illustrated by the solid line in FIG. 2, a value of the inclination angle α is +(plus) when the radiation surface 56C is positioned further rearward than the vertical direction 101. However, as illustrated by the dashed line in FIG. 2, the value of the inclination angle α is—(minus) when the radiation surface 56C is positioned further forward than the vertical direction 101. In other words, when the inclination angle α exceeds 0°, the angle of elevation formed between the normal direction to the radiation surface 56C of the radiation plate 56 and a horizontal plane is from 0° up to and including+15°.

Furthermore, when the inclination angle α is less than 0°, the angle of dip formed between the normal direction to the radiation surface 56C of the radiation plate 56 and a horizontal plane is from 0° down to and including −15°. Note that in the present specification, an angle of elevation has a +(plus) magnitude, and an angle of dip has a −(minus) magnitude. The antenna gain in the horizontal plane direction of the antenna 50 is not liable to drop when the inclination angle α is in the range of ±15°. Note that the inclination angle α is preferably in a range of ±10°, is more preferably in a range of ±5°, is still more preferably in a range of ±3°, is especially preferably in a range of ±10, and is most preferably 0°.

Description continues regarding a working example (Example 1) of the above exemplary embodiment, while making a comparison to a comparative example (Example 2).

### COMPARATIVE EXAMPLE

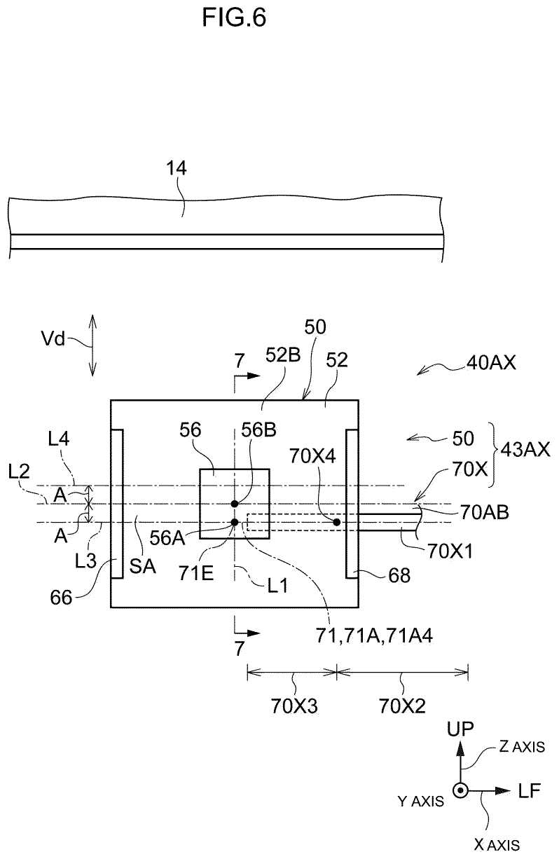

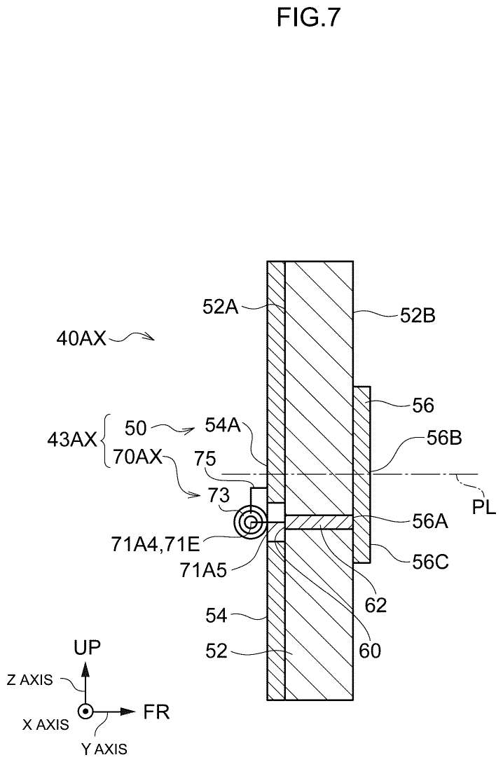

An antenna device 43AX of Example 2 illustrated in FIG. 6 and FIG. 7 is a comparative example including an antenna 50 and a coaxial cable 70X. The coaxial cable 70X has the same structure as the coaxial cable 70A. However, in front view the coaxial cable 70X includes a non-overlapping portion 70X2 and an overlapping portion 70X3 disposed on a third straight line L3 passing in an X axis direction through a connection point 56A positioned below a centroid 56B of the antenna 50. Note that the non-overlapping portion 70X2, the overlapping portion 70X3, and an intersection portion 70X4 of the coaxial cable 70X respectively correspond to the non-overlapping portion 70A2, the overlapping portion 70A3, and the intersection portion 70A4 of the coaxial cable 70A in the antenna device 43A.

Furthermore, a bending portion 71E is provided at one location on the end portion 71A of the coaxial cable 70X. Locations of the end portion 71A positioned between the end portion of a straight line shaped portion 70X1 and the bending portion 71E configure a first portion 71A4 parallel to the straight line shaped portion 70X1. Locations between a distal end of the end portion 71A and the bending portion 71E configure a second portion 71A5 parallel to the Y axis and substantially orthogonal to the first portion 71A4. The distal end of the second portion 71A5 is connected to the connecting conductor 62, and is connected to the feeding portion 60 through the connecting conductor 62. Namely, the end portion 71A of the coaxial cable 70X has an L-shape. In front view of the antenna 50, the bending portion 71E overlaps with the connection point 56A of the radiation plate 56. Namely, in the comparative example the axis of the coaxial cable 70X does not overlap with the straight line L2 and so, when “L53/2” is taken as 100%, a proportion of the length L_{C} described above is 0%.

### Working Example

The antenna device 43A of Example 1 illustrated in FIG. 3 and FIG. 4 is a working example, and the coaxial cable 70A is disposed along the straight line L2, the end portion 71A of the coaxial cable 70A is bent, and the distal end thereof is connected to the feeding portion 60 through the connecting conductor 62.

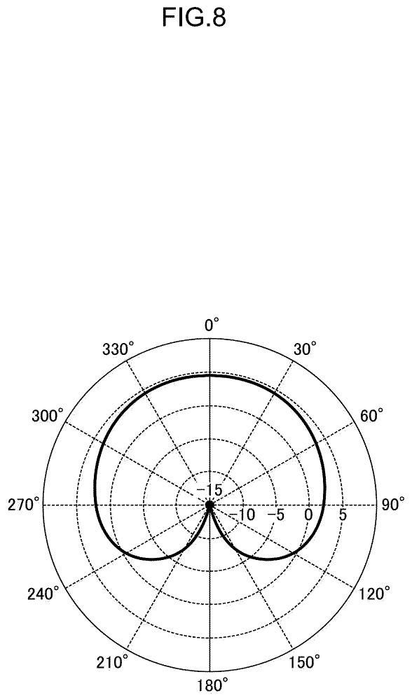

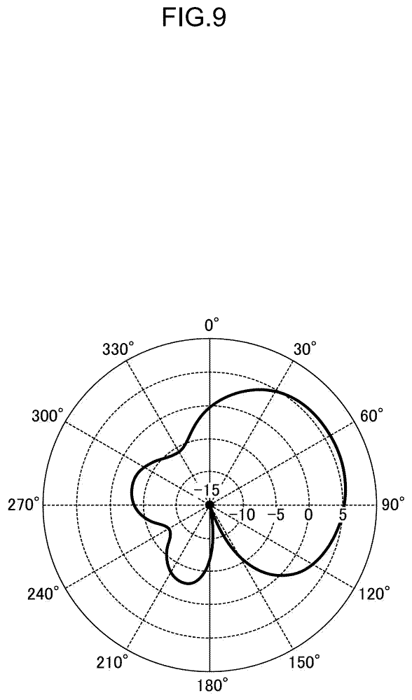

FIG. 8 illustrates directionality of the antenna device 43A of Example 1, and FIG. 9 illustrates directionality of the antenna device 43AX of Example 2. FIG. 8 and FIG. 9 illustrate simulation results of antenna gain in the 5.9 GHz band for each direction in a horizontal plane, namely in the XY plane 100. 0° indicates forward in the vehicle front-rear direction, 90° indicates the right side in the vehicle width direction, 180° indicates rearward in the vehicle front-rear direction, and 270° indicates the left side in the vehicle width direction.

Reference signs L20, L21, L50, L51, L53, L55, L60, L61, L62 in FIG. 3 to FIG. 5 indicate each dimension of portions of the vehicle antenna device 40A and the vehicle antenna device 40AX of Example 1 and Example 2, and are as set out below. Units for each of the following numerical values are mm. The directionality of FIG. 8 and FIG. 9 are results when these numerical values were calculated for each portion. Note that L55 is a distance in the Y axis direction between the first element 66 and second element 68, and the radiation surface 56C.
L20: 14
L21: 14
L50: 17
L51: 1.5
L53: 20
L55: 0
L60: 20
L61: 29
L62: 0.75
L: 20
L_{C}: 10
L_{E}: 30
D1: 4
A: 4
70A2 (length L): 20
Note that α=0° and 01=22.5° is assumed.

As is clear from FIG. 8 and FIG. 9, directionality of the antenna device 43A of Example 1 in the range from 0° to +90° and in the range from 0° to 270° (−90°) is better than the directionality of the antenna device 43AX of Example 2 in the range from 0° to +90° and in the range from 0° to 270° (−90°). Namely, the antenna device 43A is able to implement balance antenna gain and directionality over the range from 270° (−90°) to +90°, including the 0° direction. In particular, the antenna gain of the antenna device 43AX of Example 2 in the range of from 0° to 270° (−90°) more sharply drops compared to the antenna gain in the same range of the antenna device 43A of Example 1.

In the first exemplary embodiment as described above, the transmission line (the coaxial cable 70A) is disposed inside the specified area SA in front view of the ground conductor plate 54. Namely, at least part of the overlapping portion 70A3 of the coaxial cable 70A overlaps with the second straight line L2 passing through the centroid 56B of the antenna 50 in the X axis direction. Furthermore, at least part of the non-overlapping portion 70A2 of the coaxial cable 70A overlaps with the second straight line L2. This means that in Example 1, there is hardly any disorder in directionality due to the wiring of the coaxial cable 70A for the vertically polarized waves being transmitted and received by the antenna device 43A, enabling stable antenna gain and directionality to be implemented over a prescribed range (from −90° to +90°) in the horizontal plane.

However, in Example 2 (comparative example), part of the overlapping portion 70X3 of the coaxial cable 70X is not disposed inside the specified area SA, and is instead disposed jutting out from the specified area. In particular, in the antenna device 43AX of Example 2, the placement of the coaxial cable 70X is greatly displaced from the straight line L2 that serves as a basis line of symmetry of the antenna 50. This means that the antenna device 43AX is unable to implement desired antenna gain in the prescribed range (from −90° to +90°) in the horizontal plane, and as a result disorder appears in the directionality.

Furthermore, in the antenna device 43AX, not only does disorder arise in the radio waves in a forward area of the radiation plate 56 of the antenna 50 caused by the coaxial cable 70X, but it was also confirmed that there was disorder of radio waves in an outer peripheral area of the antenna 50, and this was confirmed as a possible cause of the drop in the antenna gain of the antenna 50 and consequently disorder in the directionality.

In the antenna device 43A (of Example 1) according to the first exemplary embodiment, the non-overlapping portion 70A2 is positioned on the second straight line L2 in front view, and the X axis direction length L of the non-overlapping portion 70A2 preferably satisfies L≥0.10×λ×k, as described above. Furthermore, length L_{E} preferably satisfies L_{E}≥0.20×λ×k. In cases in which the above is satisfied, and in particular when the antenna device 43A includes a parasitic conductor plate such as the first element 66 and the second element 68, a significant advantageous effect is readily exhibited on the directionality of the antenna 50. In this manner, in cases in which the non-overlapping portion 70A2, which is positioned inside the specified area SA in front view (is particularly positioned on the second straight line L2), has a prescribed length, the coaxial cable 70A in the outer peripheral area of the antenna 50 tends to cause less disorder in the directionality of radio waves being transmitted and received by the antenna 50. This means that the directionality of the antenna 50 of Example 1 is stable irrespective of the non-overlapping portion 70A2 of the coaxial cable 70A being positioned in the outer peripheral area of the antenna 50.

Furthermore, the non-overlapping portion 70A2 and the overlapping portion 70A3 extend in the X axis direction (parallel to the principal surface 52B) instead of in the Y axis (depth) direction, and so the size of the antenna device 43A can be made small in the Y axis direction (thickness direction), enabling a space saving to be achieved.

### Second Exemplary Embodiment

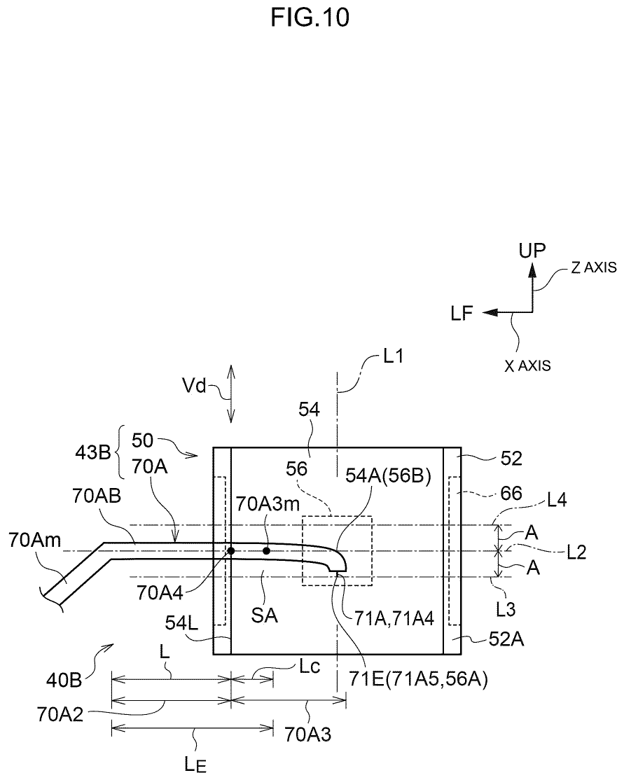

Next, description follows regarding a vehicle antenna device 40B according to a second exemplary embodiment of the present disclosure, with reference to FIG. 10. Note that the same reference numerals will be appended in the drawings to configuration the same as that of the first exemplary embodiment, and detailed explanation thereof will be omitted.

An antenna device 43B of the second exemplary embodiment is capable of transmitting and receiving linearly polarized waves, and includes an antenna 50 and a coaxial cable (transmission line) 70A. Furthermore, a vehicle antenna device 40B includes a windshield 28 (omitted from illustration in FIG. 10) and the antenna device 43B, and is capable of transmitting and receiving vertically polarized waves. One end portion 71A of a signal line 71 of the coaxial cable 70A has the same structure as the end portion 71A of the coaxial cable 70X of the vehicle antenna device 40AX. Namely, the one end portion 71A of the signal line 71 of the coaxial cable 70A has an L-shape, with a distal end of a second portion 71A5 connected to a feeding portion 60. A bending portion 71E of the antenna device 43B overlaps with a connection point 56A of a radiation plate 56 in front view of a ground conductor plate 54.

The relative positions of the antenna 50 and the coaxial cable 70A are maintained in the state illustrated in FIG. 10 by a non-illustrated fixing means, such as the above connector or the like. Furthermore, a main body 70AB includes a non-overlapping portion 70A2, an overlapping portion 70A3, and an intersection portion 70A4. The non-overlapping portion 70A2 is positioned on the second straight line L2 in front view. Locations of a straight line shape between an intermediate portion 70A3m of the overlapping portion 70A3 and an intersection portion 70A4 are positioned on the second straight line L2 in front view. An X axis direction length of straight line shaped locations between the intermediate portion 70A3m of the overlapping portion 70A3 and the intersection portion 70A4 is a length L_{C}. L_{E} in FIG. 10 is the sum of length L and length L_{C}. Preferably the X axis direction length L of the non-overlapping portion 70A2 satisfies L≥0.10×λ×k, wherein, and k have the definitions given above. Furthermore, the above mentioned length L_{E} preferably satisfies L_{E}≥0.20×λ×k.

In the present exemplary embodiment, the overlapping portion 70A3 of the coaxial cable 70A is disposed inside the specified area SA in front view. Furthermore, the end portion 71A overlaps with the first straight line L1 in the thickness direction of the ground conductor plate 54 in front view. Furthermore, the coaxial cable 70A is disposed such that the overlapping portion 70A3 includes locations having a substantially circular arc shape in front view. In the antenna device 43B of the present exemplary embodiment too, taking “L53/2” as 100%, then the proportion of the length L_{C} should be 30% or greater, is preferably 50% or greater, and is more preferably 70% or greater. The length L_{C} referred to here corresponds to a distance of the overlapping portion 70A3 from the intersection portion 70A4 to the intermediate portion 70A3m where the axis of the coaxial cable 70A overlaps with the straight line L2.

In the second exemplary embodiment described above, in front view the overlapping portion 70A3 of the coaxial cable 70A of the vehicle antenna device 40B is disposed inside the specified area SA. Furthermore, in front view the non-overlapping portion 70A2 overlaps with the second straight line L2 in the thickness direction of the ground conductor plate 54. This means that, similarly to in the vehicle antenna device 40A of the first exemplary embodiment, the non-overlapping portion 70A2 and the overlapping portion 70A3 of the vehicle antenna device 40B of the second exemplary embodiment are able to suppress a drop in the antenna gain over the range of 0° to 270° (−90°) of the antenna 50, enabling implementation of a prescribed directionality in a horizontal plane. This means that the antenna gain of the antenna device 43B of the second exemplary embodiment is better than the antenna gain of the antenna device 43AX of Example 2 (comparative example), enabling a prescribed directionality to be implemented in a horizontal plane. In particular, an antenna gain over a range of from 0° to 270° (−90°) of the antenna 50 of the second exemplary embodiment is better than the antenna gain over a range of from 0° to 270° (−90) for the antenna device 43AX of Example 2, improving the directionality over a range of 180° in the horizontal plane centered on a normal direction to the radiation surface 56C.

### Third Exemplary Embodiment

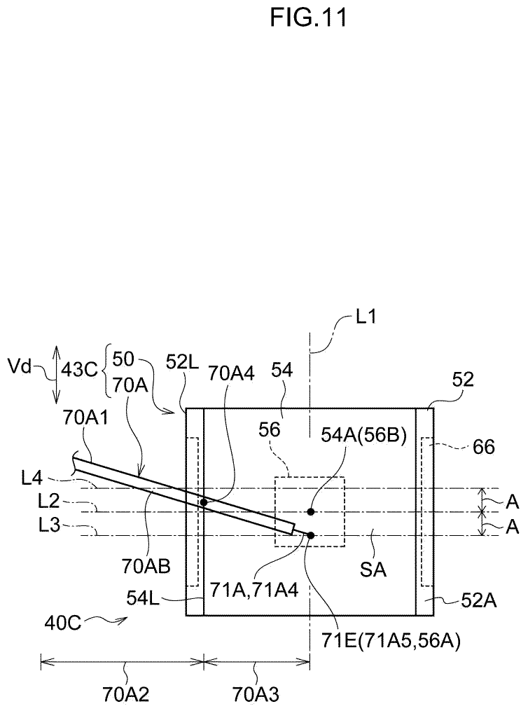

Next, description follows regarding a vehicle antenna device 40C according to a third exemplary embodiment of the present disclosure, with reference to FIG. 11. Note that the same reference numerals will be appended to configuration the same as that of the first exemplary embodiment or the second exemplary embodiment, and detailed explanation thereof will be omitted.

An antenna device 43C of the third exemplary embodiment is capable of transmitting and receiving linearly polarized waves, and includes an antenna 50 and a coaxial cable (transmission line) 70A. Furthermore, a vehicle antenna device 40C includes a windshield (omitted from illustration in FIG. 11) 28 and the antenna device 43C, and is capable of transmitting and receiving vertically polarized waves. One end portion 71A of a signal line 71 of the coaxial cable 70A has the same structure as the end portion 71A of the coaxial cable 70X of the vehicle antenna device 40AX. A distal end of a second portion 71A5 is connected to the feeding portion 60. A bending portion 71E of the antenna device 43C overlaps with a connection point 56A of a radiation plate 56 in front view of a ground conductor plate 54.

The relative positions of the antenna 50 and the straight line shaped portion 70A1 are maintained in the state illustrated in FIG. 11 by a non-illustrated fixing means, such as the above connector or the like. Namely, the straight line shaped portion 70A1 includes a non-overlapping portion 70A2, an overlapping portion 70A3, and an intersection portion 70A4. In front view the non-overlapping portion 70A2, the overlapping portion 70A3, and the end portion 71A form a substantially straight line shape. Furthermore, in front view the overlapping portion 70A3 is positioned inside the specified area SA.

In the third exemplary embodiment as described above, the overlapping portion 70A3 is disposed inside the specified area SA in front view. This means that the overlapping portion 70A3 of the third exemplary embodiment is able to suppress a drop in antenna gain over a range of from 0° to 270° (−90°) of the antenna 50, enabling a prescribed directionality to be implemented in a horizontal plane. This means that antenna gain of the antenna device 43C of the third exemplary embodiment is better than the antenna gain of the vehicle antenna device 40AX of Example 2 (comparative example), enabling implementation of a prescribed directionality in the horizontal plane. In particular, the antenna gain over a range of from 0° to 270° (−90°) of the antenna device 43C of the third exemplary embodiment is better than the antenna gain over the range of from 0° to 270° (−90°) of the antenna 50 of Example 2, improving the directionality over a range of 180° in the horizontal plane centered on a normal direction to the radiation surface 56C.

### Fourth Exemplary Embodiment

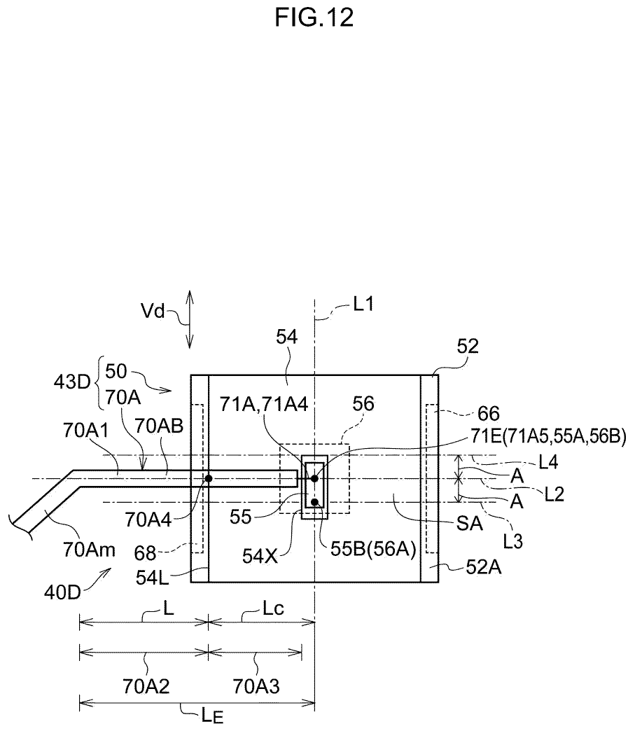

Next, description follows regarding a vehicle antenna device 40D according to a fourth exemplary embodiment of the present disclosure, with reference to FIG. 12. Note that the same reference numerals will be appended to configuration the same as that of the first exemplary embodiment to the third exemplary embodiment, and detailed explanation thereof will be omitted.

An antenna device 43D of the fourth exemplary embodiment includes an antenna 50 and a coaxial cable (first transmission line) 70A. Furthermore, the vehicle antenna device 40D of the fourth exemplary embodiment is a vertically polarized wave antenna, and includes a windshield 28 (omitted from illustration in FIG. 12) and the antenna device 43D.

The relative positions of the antenna 50 and the coaxial cable 70A are maintained in the state illustrated in FIG. 12 by a non-illustrated fixing means, such as the above connector or the like. Furthermore, the straight line shaped portion 70A1 includes a non-overlapping portion 70A2, an overlapping portion 70A3, and an intersection portion 70A4. In front view the non-overlapping portion 70A2, the overlapping portion 70A3, and the end portion 71A have a straight line shape and are also positioned on the second straight line L2. The length of locations where the overlapping portion 70A3 and the end portion 71A overlap the second straight line L2 is length L_{C}. An X axis direction length L of the non-overlapping portion 70A2 preferably satisfies L≥0.10×λ×k, wherein, and k have the definitions given above. L_{E} in FIG. 12 is the sum of length L and length L_{C}. Furthermore, the length L_{E} as defined above preferably satisfies L≥0.20×λ×k. Note that taking “L53/2” as 100%, then the proportion of the above length L_{C} in the antenna device 43D of the present exemplary embodiment is 100%.

An opening 54X having a substantially rectangular shape in front view is formed in a central portion of the ground conductor plate 54. Furthermore, a coplanar feed line (second transmission line) 55 having a substantially rectangular shaped external edge further inside than an outer edge of the opening 54X is formed to a principal surface 52B of a dielectric substrate 52. Part of the coplanar feed line 55 includes a (feed) point 55A that overlaps with the centroid 56B in front view. Furthermore, a feeding portion 55B that overlaps with a connection point 56A in front view is formed at a location separated from, and below, the (feed) point 55A of the coplanar feed line 55. The feeding portion 55B is connected to the connecting conductor 62. Furthermore, a distal end of a second portion 71A5 is connected to the (feed) point 55A of the coplanar feed line 55. A bending portion 71E and a second portion 71A5 are disposed so as to overlap with the feed point 55A and the centroid 56B of the radiation plate 56 in front view of the antenna device 43D. Note that examples of the material configuring the coplanar feed line 55 include, for example, silver or copper, however a material other than silver or copper may be employed.

In the fourth exemplary embodiment as described above, the coaxial cable 70A of the antenna device 43D is disposed inside the specified area SA in front view. Furthermore, in front view the non-overlapping portion 70A2 and the overlapping portion 70A3 overlap with the second straight line L2. This means that, similarly to in the antenna device 43A of the first exemplary embodiment, the non-overlapping portion 70A2 and the overlapping portion 70A3 of the antenna device 43D of the fourth exemplary embodiment are able to suppress a drop in the antenna gain in the range of 0° to 270° (−90°) of the antenna 50, enabling a prescribed directionality to be implemented in a horizontal plane. This means that antenna gain of the antenna device 43D of the fourth exemplary embodiment is better than the antenna gain of the vehicle antenna device 40AX of Example 2 (comparative example), enabling implementation of a prescribed directionality in the horizontal plane. In particular, the antenna gain over a range of from 0° to 270° (−90°) of the antenna device 43D of the fourth exemplary embodiment is better than the antenna gain over the range of from 0° to 270° (−90°) of the antenna device 40AX of Example 2, improving the directionality over a range of 180° in the horizontal plane centered on a normal direction to the radiation surface 56C.

Furthermore, the (feed) point 55A of the coplanar feed line 55 that is a portion of the transmission line is set so as to overlap with the centroid 56B in front view, and an end portion of the end portion 71A having an L-shape is connected to this (feed) point 55A. Namely, employing plural transmission lines including the first transmission line and the second transmission line raises the degrees of freedom for placement of the transmission line for connecting to the feeding portion 60. Furthermore, in the antenna device 43D of the present exemplary embodiment, the relative positions of the antenna 50 and the coaxial cable 70A are readily fixed by the above fixing means so as to connect the end portion of the end portion 71A to the (feed) point 55A. Note that the transmission line may be configured so as to join three or more types of transmission line together.

### Fifth Exemplary Embodiment

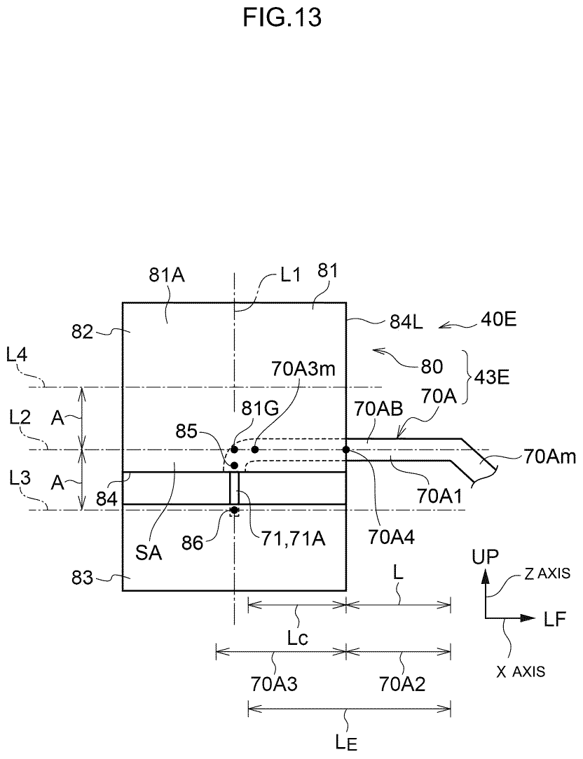

Description follows regarding a vehicle antenna device 40E according to a fifth exemplary embodiment of the present disclosure, with reference to FIG. 13. Note that the same reference numerals will be appended to configuration the same as that of the first exemplary embodiment to the fourth exemplary embodiment, and detailed explanation thereof will be omitted. The vehicle antenna device 40E of the fifth exemplary embodiment is capable of transmitting and receiving linearly polarized waves, includes a windshield 28 (omitted in FIG. 13) and an antenna device 43E, and is capable of transmitting and receiving vertically polarized waves. The antenna device 43E includes a communication antenna 80 (hereafter antenna 80) and a coaxial cable (transmission line) 70A.

The antenna 80 includes a radiation plate (radiation conductor) 81. The radiation plate 81 corresponds to a conductor plate. A surface at a front side of the radiation plate 81 in the vehicle front-rear direction configures a radiation surface 81A. The radiation surface 81A radiates vertically polarized waves Q in a 5.8 GHz band or 5.9 GHz band employed for vehicle-to-vehicle communication, roadside-to-vehicle communication, or the like.

The radiation plate 81 includes a slot 84 formed as an opening dividing the radiation surface 81A into a surface portion 82 and a surface portion 83. The slot 84 extends in an extension direction of the second straight line L2 in front view. The surface portion 82 is a conductive location positioned further upward than the slot 84. The surface portion 83 is a conductive location positioned further downward than the slot 84. The surface portion 82 includes a feed point 85, and the surface portion 83 includes a feed point 86.

The feed point 85 is electrically connected to a shield cover 73 (omitted in FIG. 13) of the coaxial cable 70A. The feed point 86 is electrically connected to an end portion 71A of the signal line 71 of the coaxial cable 70A. Note that the feed point 85 may be electrically connected to the end portion 71A of the coaxial cable 70A, and in such cases the feed point 86 is electrically connected to the shield cover 73 of the coaxial cable 70A. The antenna 80 is attached to an upper portion of a principal surface of the windshield 28 through a bracket (omitted in the drawings).

The first straight line L1 illustrated in FIG. 13 passes in the Z axis direction through a centroid 81G of the radiation plate 81 in front view. The second straight line L2 passes in the X axis direction through the centroid 81G in front view. Furthermore, in front view a straight line separated by a distance A below the second straight line L2, and passing through the feed point 86 in a direction parallel to the second straight line L2, is defined as being a third straight line L3. Furthermore, in front view, a straight line separated by a distance A above the second straight line L2, and parallel to the second straight line L2, is defined as being a fourth straight line L4. Furthermore, an area on the radiation surface 81A between the third straight line L3 and the fourth straight line L4 is called a specified area SA.

The coaxial cable 70A and the antenna 80 are maintained in the state illustrated in FIG. 13 by a non-illustrated fixing means. A portion of the main body 70AB configures a straight line shaped portion 70A1. A portion of the straight line shaped portion 70A1 made up from locations positioned further to the left side than a side edge portion 84L of the radiation plate 81 in front view is defined as being a non-overlapping portion 70A2. Furthermore, a portion of the straight line shaped portion 70A1 made up from locations overlapping with the side edge portion 84L, this being a portion of a peripheral edge portion of the radiation plate 81 in front view, and locations positioned further to a central portion side of the radiation plate 81 than the side edge portion 84L, is defined as being an overlapping portion 70A3. Locations of the coaxial cable 70A that overlap with the side edge portion 84L in front view in the thickness direction of the radiation plate 81 are defined as being an intersection portion 70A4. Straight line shaped locations between the intermediate portion 70A3m of the overlapping portion 70A3 and the intersection portion 70A4 are positioned on the second straight line L2 in front view. An X axis direction length of a straight line shaped location between the intermediate portion 70A3m of the overlapping portion 70A3 and the intersection portion 70A4 is a length L_{C}. L_{E} in FIG. 13 is the sum of length L and length L_{C}. An X axis direction length L of the non-overlapping portion 70A2 preferably satisfies L≥0.10×λ×k, wherein, and k are as defined above. Furthermore, as described above, preferably a length L_{E} satisfies length L_{E}≥0.20×λ×k. In the antenna device 43E of the present exemplary embodiment, taking a length of half the radiation plate 81 in the straight line L2 direction as being 100%, a proportion of the length L_{C} should be 30% or greater, is preferably 50% or greater, and is more preferably 70% or greater.

In the fifth exemplary embodiment too, the antenna 80 is attachable to a windshield 28 through a bracket described above such that an inclination angle of a front face portion 93 with respect to a vertical direction 101 (see FIG. 2) is a.

In the fifth exemplary embodiment described above, in front view the overlapping portion 70A3 of the coaxial cable 70A overlaps the specified area SA in the thickness direction of the radiation plate 81. Furthermore, in front view the overlapping portion 70A3 overlaps the second straight line L2 in the thickness direction of the radiation plate 81. Furthermore, at least a portion of the non-overlapping portion 70A2 of the coaxial cable 70A overlaps with the second straight line L2. This means that the antenna device 43E of the fifth exemplary embodiment is able to implement stable antenna gain and directionality over a prescribed range (from −90° to +90°) in the horizontal plane.

Although the present disclosure has been described by way of the first exemplary embodiment to the fifth exemplary embodiment, the present disclosure is not limited by these exemplary embodiments.

For example, as illustrated in FIG. 1 to FIG. 2, an antenna device 43A including an antenna 50 and a coaxial cable 70A may be attached through a non-illustrated bracket to vehicle up-down direction upper portion of a principal surface (front face) at the vehicle cabin inside of the rear glass 34. In such cases, the rear glass 34 and the antenna device 43A are configuration elements of the vehicle antenna device 40A. In such cases, the radiation surface 56C of the radiation plate 56 of the antenna 50 faces toward the rear glass 34. Note that, as illustrated in FIG. 2, the antenna 50 should be disposed such that a normal direction Dnr facing rearward with respect to the radiation surface 56C of the radiation plate 56 passes out through the rear glass 34. Note that the normal direction Dnr of FIG. 2 is a normal direction when inclination angle α is 0°.

Moreover, the antenna devices 43B, 43C, 43D, 43E may each also be attached to an upper portion of a principal surface at the vehicle cabin inside of the rear glass 34 through a bracket. In such cases, the antenna device 43B and the rear glass 34 are configuration elements of a vehicle antenna device 40B, the antenna device 43C and the rear glass 34 are configuration elements of a vehicle antenna device 40C, the antenna device 43D and the rear glass 34 are configuration of a vehicle antenna device 40D, and the antenna device 43E and the rear glass 34 are configuration of a vehicle antenna device 40E. In such cases, the radiation surface 56C of the antenna device 43B, 43C, 43D and the radiation plate 81 of the antenna device 43E face toward the rear glass 34.

Note that in cases in which the antenna devices 43A, 43B, 43C, 43D, 43E are each attached to the rear glass 34, the inclination angle α of the radiation surface 56C of the radiation plate 56 of the antenna 50 or of the radiation plate 81 is preferably within +15° with respect to a vertical direction 102 when a rear section of the vehicle 10 is viewed from the left side as illustrated in FIG. 2.

In cases in which the antenna device 43A, 43B, 43C, 43D, or 43E is provided to the rear glass 34 of the vehicle 10, the antenna device 43A, 43B, 43C, 43D, or 43E may or may not be provided to the windshield 28. In cases in which the antenna device 43A, 43B, 43C, 43D, or 43E is provided to the windshield 28 and also the antenna device 43A, 43B, 43C, 43D, or 43E is provided to the rear glass 34, in the manner illustrated in FIG. 1, a desired antenna gain can be implemented over a range of from 0° to 360° in a horizontal plane by a combined value of the antenna gain of the front antenna device 43A, 43B, 43C, 43D, or 43E and the antenna gain of the rear antenna device 43A, 43B, 43C, 43D, or 43E.

The antenna devices 43A, 43B, 43C, 43D, 43E may be horizontal polarized wave antennas having a higher antenna gain for transmitting and receiving horizontally polarized waves than for vertically polarized waves. In such cases, in front view preferably the antenna devices 43A, 43B, 43C, 43D, 43E are each attached to the vehicle 10 such that the first straight line L1 is parallel to the X axis direction.

In cases in which the antenna devices 43A, 43B, 43C, 43D, 43E are each a vertically polarized wave antenna, the antenna devices 43A, 43B, 43C, 43D, 43E may be each preferably provided to the vehicle 10 such that an angle formed in front view between the straight line L1 and a vertical direction is not greater than 15°. Moreover, in cases in which the antenna devices 43A, 43B, 43C, 43D, 43E are each a horizontal polarized wave antenna, the antenna device 43A, 43B, 43C, 43D, 43E may be provided to the vehicle 10 such that an angle formed in front view between the straight line L2 and a vertical direction is not greater than 15°.

Plural of the antenna devices 43A, 43B, 43C, 43D, 43E may be attached to the windshield 28. Moreover, plural of the antenna devices 43A, 43B, 43C, 43D, 43E may be attached to the rear glass 34.

The antenna device 43E of the fifth exemplary embodiment may include a ground conductor plate disposed alongside the radiation plate 81 in the Y axis direction. Furthermore, the antenna device 43E may include a parasitic conductor plate. Such a parasitic conductor plate may have a Y axis direction position further toward the radiation plate 81 side than a ground conductor plate.

The rear glass 34 may be provided to a back door (omitted in the drawings) that opens and closes off an opening provided to a rear section of the vehicle 10.

What is claimed is:

1. An antenna device comprising:
an antenna that transmits and receives radio waves of a prescribed frequency band; and
a transmission line that feeds electricity to a conductor plate that is a portion of the antenna, wherein:
the conductor plate includes a radiation plate that is equipped with a radiation surface for radiating radio waves and is equipped with a feed point that is a location supplied with power from the transmission line;
the feed point is provided at a position separated by a distance A from a centroid of the radiation plate when the radiation plate is viewed along a horizontal direction; and
when given a first straight line that passes through the centroid and the feed point, a second straight line that is orthogonal to the first straight line and passes through the centroid, a third straight line that passes through the feed point and is parallel to the second straight line, and a fourth straight line that is parallel to the second straight line and is symmetrical to the third straight line with respect to the second straight line, and when the centroid overlaps with the conductor plate when viewed along the thickness direction of the radiation plate,
when viewed along the thickness direction of the radiation plate, locations between an end portion of the transmission line connected to the feed point and an intersection portion intersecting with a peripheral edge portion of the conductor plate overlap in the thickness direction of the radiation plate with a specified area between the third straight line and the fourth straight line.

2. The antenna device of claim 1, wherein the intersection portion of the transmission line overlaps with an intersection point between the peripheral edge portion of the conductor plate and the second straight line in the thickness direction of the radiation plate.

3. The antenna device of claim 1, wherein the transmission line includes a bending portion that overlaps with the centroid in the thickness direction of the radiation plate.

4. The antenna device of claim 1, wherein the radiation plate has a rectangular shaped profile in front view.

5. The antenna device of claim 1, wherein:
L_{E}≥0.20×λ×k is satisfied, wherein
L_{E} is a length L_{E} of locations on the transmission line including locations that overlap with the specified area in the thickness direction of the radiation plate and that are positioned on the second straight line,
λ is a wavelength in air of the radio waves, and
k is a shortening coefficient of wavelength of a surrounding medium.

6. The antenna device of claim 1, wherein the antenna is a slot antenna including a slot that extends in a direction parallel to the second straight line of the radiation plate.

7. The antenna device of claim 6, wherein:
L≥0.10×λ×k is satisfied, wherein
L is a length of locations of the transmission line positioned further toward an outer peripheral side of the radiation plate than a peripheral edge portion of the radiation plate and extending along the second straight line,
λ is a wavelength in air of the radio waves, and
k is a shortening coefficient of wavelength of a surrounding medium.

8. The antenna device of claim 6, wherein, taking a length of half a length of the radiation plate lying on the second straight line as being 100%, and taking locations that are a portion of the transmission line and that overlap with the radiation plate when viewed along the thickness direction as an overlapping portion, a proportion of a length L_{C} of locations of the overlapping portion that overlap with the second straight line is 30% or greater.

9. The antenna device of claim 1, wherein the antenna includes the radiation plate, a ground conductor plate that is a portion of the conductor plate, and a dielectric substrate that is interposed between the radiation plate and the ground conductor plate.

10. The antenna device of claim 9, wherein:
L≥0.10×λ×k is satisfied,
L is a length of locations of the transmission line positioned further toward an outer peripheral side of the ground conductor plate than a peripheral edge portion of the ground conductor plate and extending along the second straight line,
λ is a wavelength in air of the radio waves, and
k is a shortening coefficient of wavelength of a surrounding medium.

11. The antenna device of claim 9, wherein, taking a length of half a length of the ground conductor plate lying on the second straight line as being 100%, and taking locations that are a portion of the transmission line and that overlap with the ground conductor plate when viewed along the thickness direction as an overlapping portion, a proportion of a length L_{C} of locations of the overlapping portion that overlap with the second straight line is 30% or greater.

12. The antenna device of claim 9, wherein a centroid of the ground conductor plate and the centroid of the radiation plate overlap in the thickness direction of the radiation plate, and a peripheral edge portion of the ground conductor plate is positioned further toward an outer peripheral side than a peripheral edge portion of the radiation plate.

13. The antenna device of claim 9, wherein the antenna includes at least one parasitic conductor plate not overlapping with the centroid of the radiation plate in the thickness direction of the radiation plate.

14. The antenna device of claim 13, wherein:
the antenna includes the ground conductor plate disposed alongside the radiation plate in the thickness direction of the radiation plate, and two parasitic conductor plates at positions further toward the radiation plate than the ground conductor plate; and
the centroid of the radiation plate is positioned between the two parasitic conductor plates in the thickness direction of the radiation plate.

15. The antenna device of claim 1, wherein the transmission line is configured including a first transmission line, and a second transmission line of a different type from the first transmission line.

16. The antenna device of claim 15, wherein the first transmission line opposes a face of the antenna on an opposite side from the radiation surface in the thickness direction of the radiation plate, and the second transmission line is positioned on the radiation surface side of the antenna.

17. The antenna device of claim 15, wherein the first transmission line extends along the second straight line to a position overlapping with the centroid in the thickness direction of the radiation plate, and the second transmission line extends along the first straight line from a position overlapping with the centroid in the thickness direction to the feed point.

18. The antenna device of claim 17, wherein the first transmission line is a coaxial cable, and the second transmission line is a coplanar feed line.

19. A vehicle antenna device comprising:
a vehicle window glass provided at a vehicle; and
the antenna device of claim 1 disposed such that the radiation surface faces toward the vehicle window glass,
wherein, in the thickness direction of the radiation plate, an angle formed between the first straight line or the second straight line and an up-down direction of the vehicle is within 15°.

20. The vehicle antenna device of claim 19, wherein:
in the thickness direction of the radiation plate, an angle formed between the first straight line and the up-down direction of the vehicle is within 15°; and
the frequency band includes a 5.8 GHz band or a 5.9 GHz band.
